(19) United States
(12) Patent Application Publication
(10) Pub. No.: US 2025/0167477 A1
(43) Pub. Date: May 22, 2025

(54) Connector Assembly and Related Methods

(71) Applicant: Aptiv Technologies AG, Schaffhausen (CH)

(72) Inventor: Kevin S. Turner, Vienna, OH (US)

(21) Appl. No.: 18/950,319

(22) Filed: Nov. 18, 2024

Related U.S. Application Data
(60) Provisional application No. 63/601,342, filed on Nov. 21, 2023.

(51) Int. Cl. H01R 13/42; H01R 43/20

(52) U.S. Cl. CPC H01R 13/42; H01R 43/20; H01R 2201/26

(57) ABSTRACT

A connector assembly includes a connector body defining a cavity and having a rim extending around the cavity. The connector assembly includes a terminal housing removably-disposed within the cavity. The connector assembly includes a cover removably-coupled to the connector body. The cover includes a shoulder and a rail disposed adjacent to the shoulder. In an assembled orientation, the shoulder is configured to engage the rim, and the rail is disposed within the cavity and is configured to engage the terminal housing to secure the terminal housing within the cavity.

### CROSS-REFERENCE TO RELATED APPLICATIONS

This application claims the benefit of U.S. Provisional Application No. 63/601,342 filed Nov. 21, 2023, the entire disclosure of which is incorporated by reference.

### FIELD

The present disclosure relates to a connector assembly and more particularly to a connector assembly having a position assurance member for securing a position of a terminal module relative to a connector body.

### BACKGROUND

Modern vehicles (e.g., automobiles) rely on electrical wiring and electrical connections to facilitate communication between various electronic components within the vehicle. Connection systems (e.g., connectors and terminals) play an important role in ensuring the integrity of these electrical connections and the reliability and performance of the vehicle. Some connector assemblies use a connector body with module terminal-receiving bodies. In some situations, it is desirable to secure the position of the terminal-receiving bodies relative to the connector body to ensure proper alignment between the connector body, the terminal-receiving bodies, and the terminals. Current designs may require position assurance locks to secure the position of the connector body relative to the terminal-receiving bodies. These known locks can lead to inefficiencies for assembly technicians in the assembly process. In view of the foregoing, while known position assurance locks for vehicle connection systems have proven acceptable for their intended purpose, a continuous need for improvement remains in the pertinent art to address the challenges associated with efficient locking of terminal-receiving bodies relative to connector bodies.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a system and method for securing a position of a terminal-receiving body relative to a connector body. One or more terminal-receiving bodies may be inserted into the connector body to a final position. The terminal-receiving bodies may be populated with terminated leads prior to, or after, insertion into the connector body. A wiredress cover may be attached to the connector body to secure a position of the terminal-receiving bodies relative to the connector body. For example, the wiredress cover may include features (e.g., rails) to engage, and secure the position of, the terminal-receiving bodies.

Another aspect of the disclosure provides a connector assembly including a connector body defining a cavity and having a rim extending around the cavity. The connector assembly includes a terminal housing removably-disposed within the cavity. The connector assembly includes a cover removably-coupled to the connector body. The cover includes a shoulder and a rail disposed adjacent to the shoulder. In an assembled orientation, the shoulder is configured to engage the rim, and the rail is disposed within the cavity and is configured to engage the terminal housing to secure the terminal housing within the cavity.

Yet another aspect of the disclosure provides a connector assembly including a connector housing having a first upper surface facing a first direction. The connector assembly includes a terminal housing removably-disposed within the connector housing and including a second upper surface facing the first direction. The connector assembly includes a cover removably-coupled to the connector housing. The cover includes a shoulder and a rail offset from the shoulder. In an assembled orientation, the shoulder is configured to engage the first upper surface, and the rail is disposed within a cavity of the connector housing and is configured to engage the second upper surface to secure the terminal housing within the cavity.

An additional aspect of the disclosure provides a method of assembling a connector assembly. The method includes disposing a terminal housing within a connector housing. The method includes coupling a cover to the connector housing. The method includes engaging a shoulder of the cover with a rim of the connector housing. The method includes disposing a rail of the cover within the connector housing. The method includes engaging the rail with the terminal housing to inhibit movement of the terminal housing relative to the connector housing.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of a connector assembly in accordance with the principles of the present disclosure.

FIG. 2 is an exploded view of the connector assembly of FIG. 1.

FIG. 3 is cross-sectional view of the connector assembly of FIG. 1.

FIG. 4 is a flowchart depicting an example method for assembling a connector assembly in accordance with the principles of the present disclosure.

In the drawings, reference numbers may be reused to identify similar and/or identical elements.

### DETAILED DESCRIPTION

### INTRODUCTION

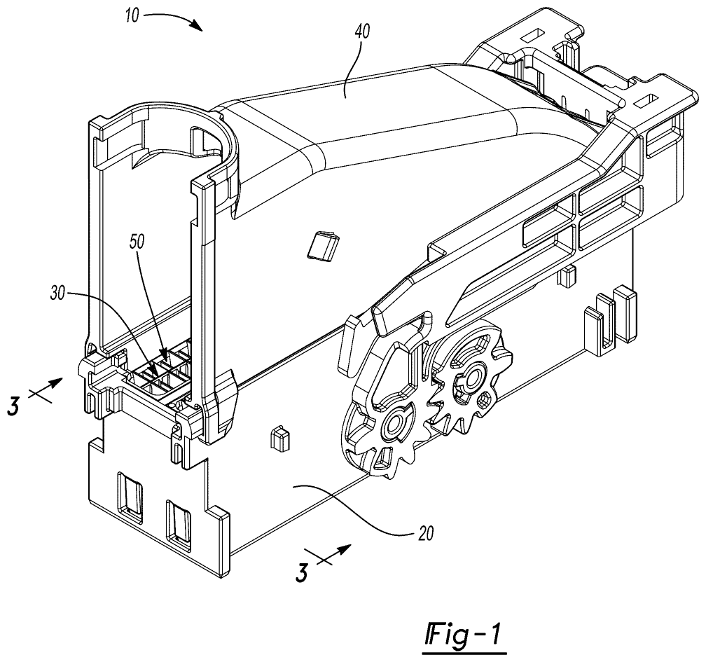

With reference to FIGS. 1-3, a connector assembly 10 is shown. As will be explained in more detail below, the connector assembly 10 may be installed in a vehicle (e.g., an automobile) to facilitate the transmission of electricity between various electronic components within the vehicle. For example, the connector assembly 10 may be detachably coupled to a mating connector assembly (not shown), such that, during operation, of the vehicle, electricity is transmitted between the connector assemblies and to various electronic components within the vehicle.

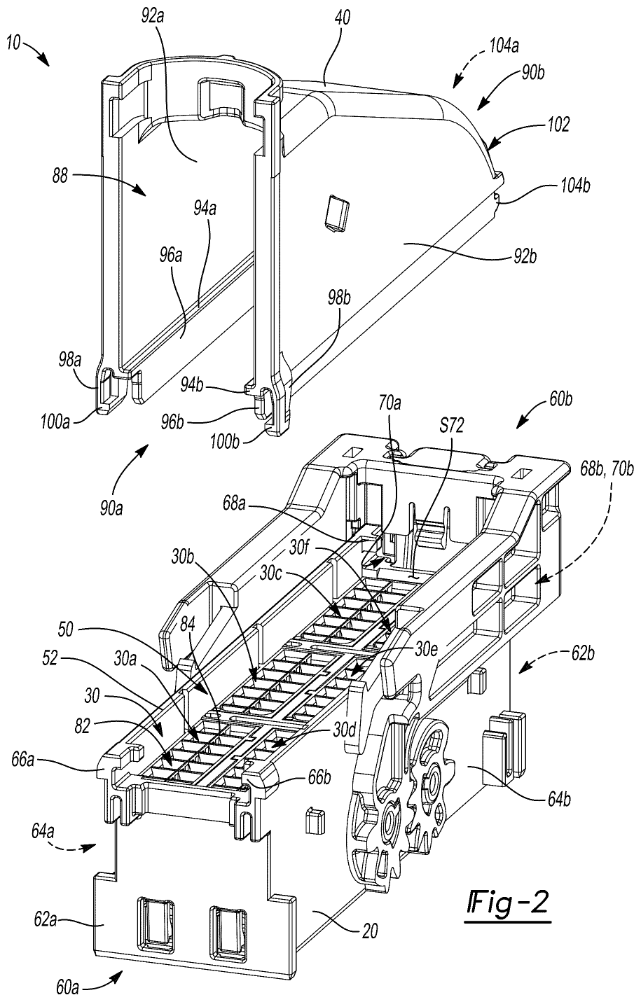

Referring now to FIGS. 1 and 2, the connector assembly 10 may include a connector body 20, a plurality of terminal housings 30 (e.g., terminal housings 30a-30f), and/or a cover 40, among others. In various implementations, the connector body 20 may define a cavity 50 and may include a rim 52 extending along the cavity 50. Each of the plurality of terminal housings 30 may be removably-disposed within the cavity 50. The cover 40 may be removably-coupled to the connector body 20. In an assembled orientation, portions of the cover 40 may engage the rim 52 of connector body 20 and/or portions of the terminal housings 30 to secure the terminal housings 30 within the cavity 50.

### Connector Body

In various implementations, the connector body 20 (i.e., a connector housing) may include a first end 60a, a second end 60b spaced apart from the first end 60a, a first end wall 62a, a second end wall 62b spaced apart from the first end wall 62a, a first sidewall 64a disposed between the first end 60a and the second end 60b, and/or a second sidewall 64b spaced apart from the first sidewall 64a, among others. The first end wall 62a may be disposed proximate the first end 60a and the second end wall 62b may be disposed proximate the second end 60b. The first end wall 62a, the second end wall 64, the first sidewall 64a, and the second sidewall 64b may collectively define the cavity 50.

In various implementations, the connector body 20 may include a first detent 66a, a second detent 66b, a first projection 68a, and a second projection 68b. The first detent 66a may be disposed proximate the first end 60a and/or may extend from the first sidewall 64a. The second detent 66b may be disposed proximate the first end 60a and/or may extend from the second sidewall 64b. In the assembled orientation, the first detent 66a and/or the second detent 66b may engage portions of the cover 40 to removably-secure the cover 40 to the connector body 20.

In various implementations, the first projection 68a may be disposed proximate the second end 60b and/or may extend from the first sidewall 64a. The second projection 68b may be disposed proximate the second end 60b and/or may extend from the second sidewall 64b. In some examples, a first slot 70a may be disposed between a surface S72 of the second end wall 62b and the first projection 68a and/or a second slot 70b may be disposed between the surface S72 and the second projection 68b. In the assembled orientation, the first projection 68a and/or the second projection 68b may engage portions of the cover 40 and/or the first slot 70a and/or the second slot 70b may receive portions of the cover 40 to removably-secure the cover 40 to the connector body 20.

### Terminal Housings

With reference to FIG. 2, the connector assembly 10 may include a first terminal housing 30a, a second terminal housing 30b, a third terminal housing 30c, a fourth terminal housing 30d, a fifth terminal housing 30e, and/or a sixth terminal housing 30f, among others. Each terminal housing (e.g., terminal housings 30a-30f) may include a plurality of terminal cavities 82 and/or an outer rim 84, among others. Each terminal cavity of the plurality of cavities 82 may receive a terminal (not shown) that connects with a corresponding terminal of the mating connector assembly to electrically connect the mating connector assembly to the connector assembly 10. The connector assembly 10 is shown including six terminal housings, however the connector assembly 10 may include more or less than six terminal housings.

### Cover

With continued reference to FIG. 2, in various implementations, the cover 40 may define an internal cavity 88 that receives and/or houses at least a portion of the mating connector assembly. The cover 40 may secure the mating connector assembly to the connector body 20. The cover 40 may include a first end 90a, a second end 90b spaced apart from the first end 90a, a first sidewall 92a disposed between the first end 90a and the second end 90b, a second sidewall 92b spaced apart from the first sidewall 92a, a first shoulder 94a, a second shoulder 94b, a first rail 96a, a second rail 96b, a first extension 98a, a second extension 98b, a first detent 100a, a second detent 100b, an end wall 102 disposed between the first sidewall 92a and the second sidewall 92b, a first protrusion 104a, and/or a second protrusion 104b, among others. The first sidewall 92a, the second sidewall 92b, and the end wall 102 may at least partially define the internal cavity 88.

In various implementations, the first shoulder 94a may extend from the first sidewall 92a and/or the second shoulder 94b may extend from the second sidewall 92b. In some examples, the first shoulder 94a may extend, continuously and uninterrupted, along an entire length of the first sidewall 92a and/or the first shoulder 94a may extend in a direction towards the second sidewall 92b. The second shoulder 94b may extend, continuously and uninterrupted, along an entire length of the second sidewall 92b and/or the second shoulder 94b may extend in a direction towards the first sidewall 92a. The second shoulder 94b may be substantially (e.g., ±10 degrees) parallel to the first shoulder 94a.

The first and second rails 96a, 96b may be disposed adjacent to the first and second shoulders 94a, 94b, respectively. In various implementations, the first rail 96a may extend from the first shoulder 94a and/or the second rail 96b may extend from the second shoulder 94b. In some examples, the first rail 96a may extend in a direction that is perpendicular to the first shoulder 94a and/or the second rail 96b may extend in a direction that is perpendicular to the second shoulder 94b. The second rail 96b may be substantially (e.g., ±10 degrees) parallel to the first rail 96a. In some instances, the first rail 96a may be offset from the first shoulder 94a and/or the second rail 96b may be offset from the second shoulder 94b. In the assembled orientation, the first rail 96a and/or the second rail 96b may be disposed within the cavity 50 of the connector body 20. The first rail 96a may engage the outer rims 84 of the first terminal housing 30a, the second terminal housing 30b, and/or the third terminal housing 30c to secure the terminal housings 30a-30c within the cavity 50 of the connector body 20. The second rail 96b may engage the outer rims 84 of the fourth terminal housing 30d, the fifth terminal housing 30e, and/or the sixth terminal housing 30f to secure the terminal housings 30d-30f within the cavity 50 of the connector body 20.

In various implementations, the first extension 98a may be disposed proximate the first end 90a and/or may extend from the first sidewall 92a. The second extension 98b may be disposed proximate the first end 90a and/or may extend from the second sidewall 92b. At least a portion of the first extension 98a may be substantially (e.g., ±10 degrees) parallel to the second extension 98b.

In various implementations, the first detent 100a may extend from the first extension 98a and/or the second detent 100b may extend from the second extension 98b. In some examples, the first detent 100a may be substantially (e.g., ±10 degrees) parallel to the second detent 100b. The first detent 100a may be substantially (e.g., ±10 degrees) parallel to the first shoulder 94a and/or the second detent 100b may be substantially (e.g., ±10 degrees) parallel to the second shoulder 94b. In the assembled orientation, the first detent 100a may engage the first detent 66a of the connector body 20 and/or the second detent 100b may engage the second detent 66b of the connector body 20 to removably-secure the cover 40 to the connector body 20.

In various implementations, the end wall 102 may be disposed proximate the second end 90b and/or the first end 90a of the cover 40 may be open such that the internal cavity 88 is accessible. In some examples, the first protrusion 104a and/or the second protrusion 104b may extend from the end wall 102. The first protrusion 104a may be spaced apart from the second protrusion 104b. The first protrusion 104a may be disposed proximate the first sidewall 92a and/or the second protrusion 104b may be disposed proximate the second sidewall 92b. In the assembled orientation, the first protrusion 104a may be disposed within the first slot 70a of the connector body 20 and/or the second protrusion 104b may be disposed within the second slot 70b of the connector body 20 to removably-secure the cover 40 to the connector body 20.

### Assembled Orientation

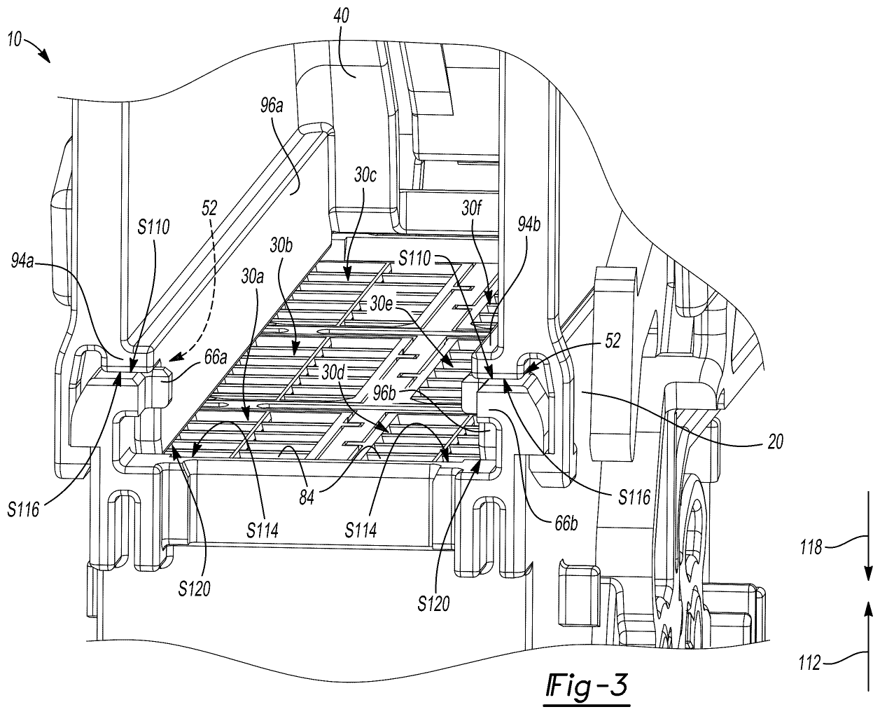

Referring now to FIG. 3, in the assembled orientation, the plurality of terminal housings 30 (e.g., terminal housings 30a-30f) may be removably-disposed within the cavity 50 of the connector body 20. The cover 40 may be removably-coupled to the connector body 20 such that the shoulders 94a, 94b of the cover 40 engage the rim 52 of the connector body 20 and the rails 96a, 96b of the cover 40 engage the outer rims 84 of the terminal housings 30 to secure the terminal housings 30 within the cavity 50.

In various implementations, the connector housing 20 may include a first upper surface S110 that faces a first direction 112, each terminal housing (e.g., 30a-30f) may include a second upper surface S114 that faces the first direction 112, each shoulder (e.g., shoulders 94a, 94b) of the cover 40 may include a first engagement surface S116 that faces a second direction 118, and/or each rail (e.g., rails 96a, 96b) of the cover 40 may include a second engagement surface S120 that faces the second direction 118. In the assembled orientation, the first upper surface S110 of the connector housing 20 may engage the first engagement surface S116 of the first shoulder 94a and/or the second shoulder 94b. The second upper surface S114 of each terminal housing 30 may engage the second engagement surface S120 of the first rail 96a or the second rail 96b.

### Flowchart

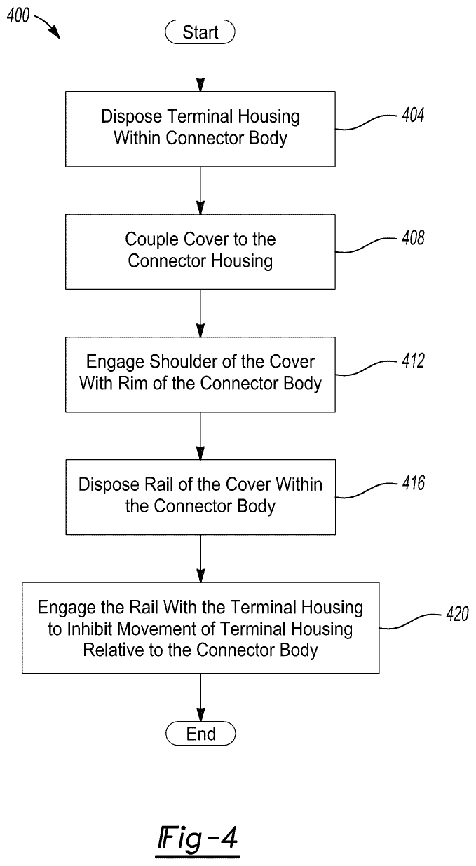

FIG. 4 is a flowchart of an example method 400 for assembling a connector assembly 10. The method 400 may begin at 404. At 404, a user may dispose a terminal housing 30 within a connector housing 20. The method 400 may proceed to 408. At 408, the user may couple a cover 40 to the connector housing 20. The method 400 may proceed to 412. At 412, the user may engage a shoulder 94a, 94b of the cover 40 with a rim 52 of the connector housing 20. The method 400 may proceed to 416.

At 416, the user may dispose a rail 96a, 96b of the cover 40 within the connector housing 20. The method 400 may proceed to 420. At 420, the user may engage the rail 96a, 96b with the terminal housing 30 to inhibit movement of the terminal housing 30 relative to the connector housing 20. In some implementations, the user may engage the rail 96a, 96b with an outer rim 84 of the terminal housing 30. In particular, in some implementations, the user may engage a first engagement surface S116 of the shoulder 94a, 94b with a first upper surface S110 of the connector housing 20, and engage a second engagement surface S120 of the rail 96a, 96b with the terminal housing 30. The user may further engage a detent 66a, 66b and/or a projection 68a, 68b of the connector housing 20 with a detent 100a, 100b and/or a second protrusion 104a, 104b of the cover 40 to removably-secure the cover to the connector housing. Then the method 400 may end.

The following Clauses provide an exemplary configuration for a connector assembly and related methods, as described above.

Clause 1: A connector assembly comprising: a connector body defining a cavity and including a rim extending around the cavity; a terminal housing removably-disposed within the cavity; and a cover removably-coupled to the connector body, the cover including a shoulder and a rail disposed adjacent to the shoulder, wherein, in an assembled orientation, the shoulder is configured to engage the rim, and the rail is disposed within the cavity and configured to engage the terminal housing to secure the terminal housing within the cavity.

Clause 2: The connector assembly of clause 1, wherein the terminal housing includes an outer rim, and wherein the rail is configured to engage the outer rim.

Clause 3: The connector assembly of any of clauses 1 through 2, wherein the rail extends from the shoulder.

Clause 4: The connector assembly of any of clauses 1 through 3, wherein the cover includes a second shoulder and a second rail extending from the second shoulder.

Clause 5: The connector assembly of clause 4, wherein the second shoulder is substantially parallel to the shoulder.

Clause 6: The connector assembly of clause 4, wherein the second rail is substantially parallel to the rail.

Clause 7: The connector assembly of any of clauses 1 through 6, wherein the shoulder includes a first engagement surface extending in a first direction and configured to engage the rim, and the rail includes a second engagement surface extending in the first direction and configured to engage the terminal housing.

Clause 8: The connector assembly of any of clauses 1 through 7, wherein: the connector body includes a wall and a first detent extending from the wall; and the cover includes a second detent configured to engage the first detent to removably-secure the cover to the connector body.

Clause 9: The connector assembly of clause 8, wherein the wall at least partially defines the cavity.

Clause 10: The connector assembly of any of clauses 1 through 9, further comprising a second terminal housing removably-disposed within the cavity, wherein, in the assembled orientation, the rail is configured to engage the second terminal housing.

Clause 11: A connector assembly comprising: a connector housing including a first upper surface facing a first direction; a terminal housing removably-disposed within the connector housing and including a second upper surface facing the first direction; and a cover removably-coupled to the connector housing, the cover including a shoulder and a rail offset from the shoulder, wherein, in an assembled orientation, the shoulder is configured to engage the first upper surface, and the rail is disposed within a cavity of the connector housing and configured to engage the second upper surface to secure the terminal housing within the cavity.

Clause 12: The connector assembly of clause 11, wherein the terminal housing includes an outer rim, and wherein the rail is configured to engage the outer rim.

Clause 13: The connector assembly of any of clauses 11 through 12, wherein the rail extends from the shoulder.

Clause 14: The connector assembly of any of clauses 11 through 13, wherein the cover includes a second shoulder and a second rail extending from the second shoulder.

Clause 15: The connector assembly of clause 14, wherein the second shoulder is substantially parallel to the shoulder.

Clause 16: The connector assembly of any of clauses 14 through 15, wherein the second rail is substantially parallel to the rail.

Clause 17: The connector assembly of clause 16, wherein the shoulder includes a first engagement surface extending in a first direction and configured to engage the first upper surface, and wherein the rail includes a second engagement surface extending in the first direction and configured to engage the terminal housing.

Clause 18: The connector assembly of clause 11, wherein: the connector body includes a wall and a first detent extending from the wall; and the cover includes a second detent configured to engage the first detent to removably-secure the cover to the connector body.

Clause 19: The connector assembly of clause 18, wherein the wall at least partially defines the cavity.

Clause 20: The connector assembly of any of clauses 11 through 19, further comprising a second terminal housing removably-disposed within the cavity, wherein, in the assembled orientation, the rail is configured to engage the second terminal housing.

Clause 21: A method of assembling a connector assembly, the method comprising: disposing a terminal housing within a connector housing; coupling a cover to the connector housing; engaging a shoulder of the cover with a rim of the connector housing; disposing a rail of the cover within the connector housing; and engaging the rail with the terminal housing to inhibit movement of the terminal housing relative to the connector housing.

Clause 22: The method of clause 21, wherein the terminal housing includes an outer rim, and wherein the method further comprises engaging the rail with the outer rim.

Clause 23: The method of any of clauses 21 through 22, wherein the shoulder includes a first engagement surface extending in a first direction, and the rail includes a second engagement surface extending in the first direction, and wherein the method further comprises: engaging the first engagement surface with the rim; and engaging the second engagement surface with the terminal housing.

Clause 24: The method of any of clauses 21 through 23, wherein the connector body includes a wall and a first detent extending from the wall, and the cover includes a second detent, and wherein the method further comprises engaging the first detent with the second detent to removably-secure the cover to the connector body.

Clause 25: The method of any of clauses 21 through 24, further comprising: disposing a second terminal housing within the connector body; and engaging the rail with the second terminal housing.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set-in other words, in some circumstances a “set” may have zero elements. The term “non-empty set” may be used to indicate exclusion of the empty set-in other words, a non-empty set will always have one or more elements. The term “subset” does not necessarily require a proper subset. In other words, a “subset” of a first set may be coextensive with (equal to) the first set. Further, the term “subset” does not necessarily exclude the empty set-in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

What is claimed is:

1. A connector assembly comprising:
a connector body defining a cavity and including a rim extending around the cavity;
a terminal housing removably-disposed within the cavity; and
a cover removably-coupled to the connector body, the cover including a shoulder and a rail disposed adjacent to the shoulder, the shoulder configured to engage the rim in an assembled orientation, and the rail disposed within the cavity and configured to engage the terminal housing to secure the terminal housing within the cavity in the assembled orientation.

2. The connector assembly of claim 1, wherein the terminal housing includes an outer rim, and wherein the rail is configured to engage the outer rim.

3. The connector assembly of claim 1, wherein the rail extends from the shoulder.

4. The connector assembly of claim 1, wherein the cover includes a second shoulder and a second rail extending from the second shoulder.

5. The connector assembly of claim 4, wherein the second shoulder is substantially parallel to the shoulder.

6. The connector assembly of claim 1, wherein the shoulder includes a first engagement surface extending in a first direction and configured to engage the rim, and wherein the rail includes a second engagement surface extending in the first direction and configured to engage the terminal housing.

7. The connector assembly of claim 1, wherein:
the connector body includes a wall and a first detent extending from the wall; and
the cover includes a second detent configured to engage the first detent to removably-secure the cover to the connector body.

8. The connector assembly of claim 1, further comprising a second terminal housing removably-disposed within the cavity, wherein, in the assembled orientation, the rail is configured to engage the second terminal housing.

9. A connector assembly comprising:
a connector body including a first upper surface facing a first direction;
a terminal housing removably-disposed within the connector body and including a second upper surface facing the first direction; and
a cover removably-coupled to the connector body, the cover including a shoulder and a rail offset from the shoulder, the shoulder configured to engage the first upper surface in an assembled orientation, and the rail disposed within a cavity of the connector body and configured to engage the second upper surface to secure the terminal housing within the cavity in the assembled orientation.

10. The connector assembly of claim 9, wherein the terminal housing includes an outer rim, and wherein the rail is configured to engage the outer rim.

11. The connector assembly of claim 9, wherein the rail extends from the shoulder.

12. The connector assembly of claim 9, wherein the cover includes a second shoulder and a second rail extending from the second shoulder.

13. The connector assembly of claim 12, wherein the second shoulder is substantially parallel to the shoulder.

14. The connector assembly of claim 9, wherein:
the connector body includes a wall and a first detent extending from the wall; and
the cover includes a second detent configured to engage the first detent to removably-secure the cover to the connector body.

15. The connector assembly of claim 9, further comprising a second terminal housing removably-disposed within the cavity, wherein, in the assembled orientation, the rail is configured to engage the second terminal housing.

16. A method of assembling a connector assembly, the method comprising:
disposing a terminal housing within a connector body;
coupling a cover to the connector body;
engaging a shoulder of the cover with a rim of the connector body;
disposing a rail of the cover within the connector body; and
engaging the rail with the terminal housing to inhibit movement of the terminal housing relative to the connector body.

17. The method of claim 16, wherein the terminal housing includes an outer rim, and wherein the method further comprises engaging the rail with the outer rim.

18. The method of claim 16, wherein the shoulder includes a first engagement surface extending in a first direction, and the rail includes a second engagement surface extending in the first direction, and wherein the method further comprises:
engaging the first engagement surface with the rim; and
engaging the second engagement surface with the terminal housing.

19. The method of claim 16, wherein the connector body includes a wall and a first detent extending from the wall, and the cover includes a second detent, and wherein the method further comprises engaging the first detent with the second detent to removably-secure the cover to the connector body.

20. The method of claim 16, further comprising:
disposing a second terminal housing within the connector body; and
engaging the rail with the second terminal housing.
